(19) United States
(12) Patent Application Publication
(10) Pub. No.: US 2025/0113402 A1
(43) Pub. Date: Apr. 3, 2025

(54) ADAPTIVE DATA TRANSMISSION

(71) Applicant: Apple Inc., Cupertino, CA (US)

(72) Inventors: Lijie Zhang, Beijing (CN); Qiang Miao, Beijing (CN); Zhiwei Wang, Beijing (CN); Huachao Xiong, Beijing (CN); Ying Zhang, Beijing (CN)

(21) Appl. No.: 18/810,163

(22) Filed: Aug. 20, 2024

Related U.S. Application Data
(60) Provisional application No. 63/586,257, filed on Sep. 28, 2023.

(51) Int. Cl. H04W 76/20; H04W 76/19; H04W 76/30

(52) U.S. Cl. CPC H04W 76/20; H04W 76/19; H04W 76/30

(57) ABSTRACT

An electronic device includes a transceiver and processing circuitry that is operatively coupled to the transceiver. The processing circuitry is configured to transmit, via the transceiver and to a second electronic device, a request for a wireless communication session with the second electronic device. The processing circuitry is also configured to communicate, via the transceiver, one or more first wireless signals during the wireless communication session with the second electronic device. Additionally, the processing circuitry is configured, after communicating the one or more first wireless signals, to extend the wireless communication session by transmitting, via the transceiver and to the second electronic device, one or more second wireless signals based on no wireless signals being communicated via the wireless communication session for a duration of time.

### CROSS-REFERENCE TO RELATED APPLICATION

This application claims the benefit of U.S. Provisional Application No. 63/586,257, filed Sep. 28, 2023, entitled “ADAPTIVE DATA TRANSMISSION,” which is incorporated by reference in its entirety for all purposes.

### BACKGROUND

The present disclosure relates generally to wireless communication, and more specifically to transmission of wireless signals wireless communication devices.

In an electronic device, a transmitter and a receiver may each be coupled to one or more antennas to enable the electronic device to both transmit and receive wireless signals. The electronic device may wirelessly communicate with other electronic devices or equipment, including network equipment such as one or more base stations. For example, a wireless communication session may be initiated to enable wireless communication between the electronic device and wireless communication circuitry of another device. In some cases, after there is a period of time during which there is no communication (e.g., transmission or reception) of wireless signals between the devices, the communication may be ended. However, in some instances, such in which data packets having relatively longer latency, the connection between the devices may be resumed to enable the data packets to be received. However, starting another communication session (to enable to the transmission and reception of the data packets) may increase the number of communication sessions between the devices, and the cessation and initiation of communication sessions may cause an undesired amount of power (e.g., electrical power provided by a battery) of one or both of the devices to be consumed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device includes a transceiver and processing circuitry that is operatively coupled to the transceiver. The processing circuitry is configured to transmit, via the transceiver and to a second electronic device, a request for a wireless communication session with the second electronic device. The processing circuitry is also configured to communicate, via the transceiver, one or more first wireless signals during the wireless communication session with the second electronic device. Additionally, the processing circuitry is configured, after communicating the one or more first wireless signals, to extend the wireless communication session by transmitting, via the transceiver and to the second electronic device, one or more second wireless signals based on no wireless signals being communicated via the wireless communication session for a duration of time.

In another embodiment, a non-transitory computer-readable medium includes instructions that, when executed by processing circuitry of an electronic device, cause the processing circuitry to transmit, via a transceiver of the electronic device and to a base station of a wireless communication network, a request for a wireless communication session with the base station over the wireless communication network. When executed, the instructions also cause the processing circuitry to communicate, via the transceiver, one or more first wireless signals during the wireless communication session with the base station. Furthermore, when executed, the instructions cause the processing circuitry to, after communicating the one or more first wireless signals, prevent the base station from ending the wireless communication session by transmitting, via the transceiver and to the base station, one or more second wireless signals based on no wireless signals being communicated via the wireless communication session for a duration of time.

In yet another embodiment, a computer-implemented method, includes receiving, via a transceiver, a request for a small data transmit (SDT) wireless communication session. The method also includes communicating, via the transceiver, one or more first wireless signals during the SDT wireless communication session. The method further includes receiving, via the transceiver, one or more second wireless signals that extend the SDT wireless communication session based on no wireless signals being communicated via the SDT wireless communication session for a duration of time.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a communication system including the user equipment of FIG. 1 communicatively coupled to a wireless communication network supported by base stations, according to embodiments of the present disclosure;

FIG. 4 is a block diagram of a communication system that may be at least partially implemented by the user equipment of FIG. 1 and/or the wireless communication network of FIG. 3, according to embodiments of the present disclosure;

FIG. 5 is a timing diagram of a process for communicating data between the user equipment of FIG. 1 and the network of FIG. 4, according to embodiments of the present disclosure;

FIG. 6 is another timing diagram illustrating communication between the user equipment of FIG. 1 and the network of FIG. 4, according to embodiments of the present disclosure;

FIG. 7 is a diagram illustrative of a process that may be performed by the user equipment of FIG. 1 to share data between the application of FIG. 4 and a processor of the user equipment, according to embodiments of the present disclosure;

FIG. 8 is a flow diagram of a process for wireless communication between the user equipment of FIG. 1 and the network of FIG. 4, according to embodiments of the present disclosure; and

FIG. 9 is a flow diagram of another process for wireless communication between the user equipment of FIG. 1 and the network of FIG. 4, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to the transmission of wireless signals between wireless communication devices, including user devices and network devices (e.g., cellular network devices such as base stations). In particular, in some wireless communication, data transmission between an electronic device (e.g., user equipment) and a network (e.g., a base station or wireless communication circuitry of a network) may be initiated by a user equipment, for example, by the user equipment transmitting an RRCResumeRequest (e.g., as defined in Third Generation Partnership Project (3GPP) Release 17 when using small data transmission (SDT)). After there is a period of time during which there is no communication (e.g., transmission or reception) of wireless signals between the devices, a radio resource control (RRC) release signal may be sent (e.g., by the network equipment to the user equipment) to end the SDT procedure. However, in some cases in which data packets having relatively longer latency, the connection (e.g., following the SDT procedure) may be resumed, which may result in more communication sessions (e.g., RRC_Conn durations) and cause relatively higher amounts of electrical power to be consumed (e.g., due to re-initiating communication sessions).

Embodiments herein provide various techniques to reduce power consumption by enabling communication sessions to be extended. The communication sessions may be SDT sessions in which the SDT procedure (e.g., to communicate data between user equipment and a network (e.g., base station)) is extended instead of entering an RRC_Conn status. Additionally or alternatively, after an SDT communication session ends, another RRCResumeRequest may be transmitted to resume communication (e.g., by starting another SDT communication session). As discussed below, the communication session between the user equipment and the network may be extended by the network or the user equipment. Thus, by extending a communication session (as opposed to ending a communication session and starting one or more later communication sessions), wireless communication between two devices (e.g., user equipment and network equipment) may be maintained while reducing power consumption (e.g., of the user equipment and/or the network equipment).

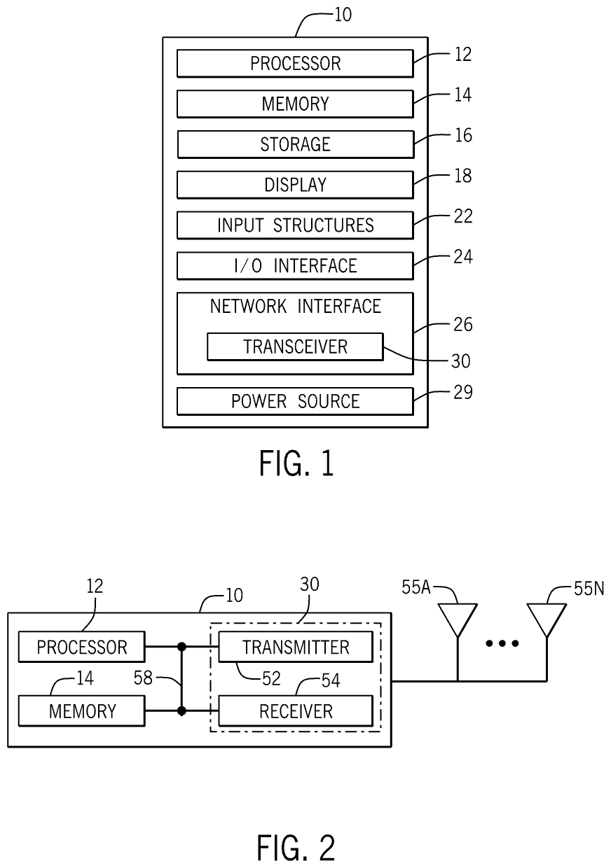

FIG. 1 is a block diagram of user equipment 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer, a portable electronic or handheld electronic device such as a wireless electronic device or smartphone, a tablet, a wearable electronic device, and other similar devices. In additional or alternative embodiments, the user equipment 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the 3GPP, including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the user equipment 10 may include any suitable source of power, such as a rechargeable lithium polymer (Li-poly) battery and/or an alternating current (AC) power converter.

The processor 12 and/or the transceiver 30 may implement various techniques to reduce power consumption by enabling communication sessions to be extended. The communication sessions may include small data transmit (SDT) sessions in which the SDT procedure (e.g., to communicate data between the user equipment 10 and a network (having one or more base stations)) is extended instead of entering an RRC_Conn status. Additionally or alternatively, after an SDT communication session ends, another RRCResumeRequest may be transmitted to resume communication (e.g., by starting another SDT communication session). As discussed below, the communication session between the user equipment 10 and the network may be extended by the network or the processor 12 and/or the transceiver 30 of the user equipment 10. Thus, by extending a communication session (as opposed to ending a communication session and starting one or more later communication sessions), wireless communication between two devices (e.g., the user equipment 10 and network equipment) may be maintained while reducing power consumption (e.g., of the user equipment 10 and/or the network equipment).

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The user equipment 10 may include the transmitter 52 and/or the receiver 54 that respectively enable transmission and reception of signals between the user equipment 10 and an external device via, for example, a network (e.g., including base stations or access points) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the user equipment 10 may be coupled together by a bus system 56. The bus system 56 may include a data bus, for example, as well as a power bus, a control signal bus, and a status signal bus, in addition to the data bus. The components of the user equipment 10 may be coupled together or accept or provide inputs to each other using some other mechanism.

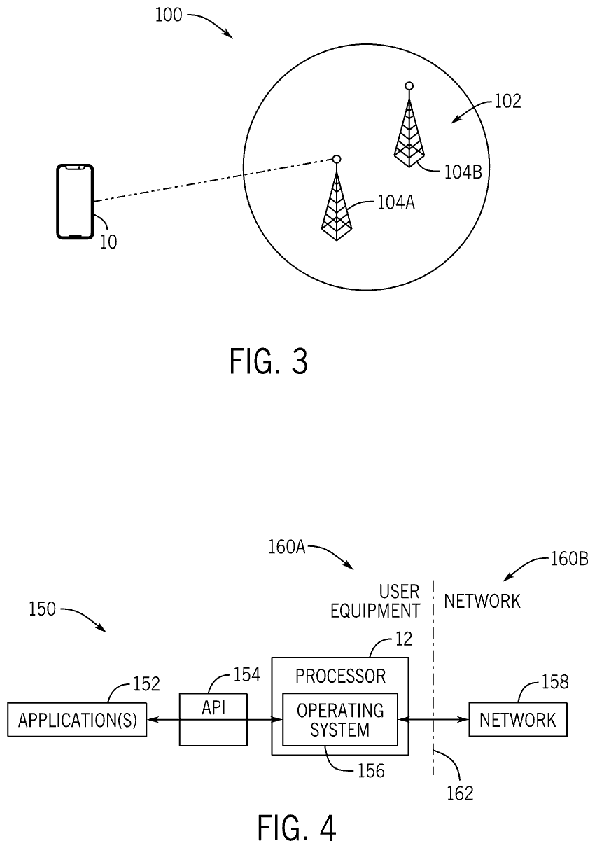

FIG. 3 is a schematic diagram of a communication system 100 including the user equipment 10 of FIG. 1 communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the user equipment 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the user equipment 10. Each of the base stations 104 may include at least some of the components of the user equipment 10 shown in FIGS. 1 and 2, including one or more processors 12, the memory 14, the storage 16, the transceiver 30, the transmitter 52, and the receiver 54. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the network 102 may include any suitable number of base stations 104 (e.g., one or more base stations 104, four or more base stations 104, ten or more base stations 104, and so on).

As noted above, the presently disclosed techniques to reduce power consumption by enabling communication sessions to be extended. The communication sessions may be SDT sessions in which the SDT procedure (e.g., to communicate data between user equipment and a network (e.g., base station)) is extended instead of entering an RRC_Conn status. Additionally or alternatively, after an SDT communication session ends, another RRCResumeRequest may be transmitted to resume communication (e.g., by starting another SDT communication session). As discussed below, the communication session between the user equipment and the network may be extended by the network or the user equipment. Thus, by extending a communication session (as opposed to ending a communication session and starting one or more later communication sessions), wireless communication between two devices (e.g., user equipment and network equipment) may be maintained while reducing power consumption (e.g., of the user equipment and/or the network equipment).

Bearing this in mind, FIG. 4 is a block diagram of a communication system 150 that, as illustrated, includes one or more applications 152, an application programming interface (API) 154, an operating system 156 (e.g., as implemented to executed by the processor 12), and a network 158. Components of the communication system 150 to one side 160A of a line 162 may be implemented by the user equipment 10, while on another side 160B of the line 162, the network 158 may be or include one or more devices or systems included in a network, such as the wireless communication network 102. As such, the network 158 may be representative of (or include) the wireless communication network 102, one or more of the base stations 104, or both the wireless communication network 102 and one or more of the base stations 104.

The one or more applications 152 (which may be referred to as an application 152 or applications 152), the API 154, and the operating system 156 may be implemented by the user equipment 10, for example, by the processor 12 executing computer-readable instructions stored in the memory 14 and/or the storage 16. Indeed, the one or more applications 152 may be programs or software (e.g., mobile applications) that may be executed by the processor 12 of the user equipment 10. The application 152 may communicate with the operating system 156 via the API 154. The operating system 156 may enable wireless communication (e.g., transmission and/or reception) of data from the applications 152 via wireless communication circuitry of the user equipment 10, such as the transceiver 30. For example, an application 152 may request access to the transceiver 30 to transmit or receive data from the network 158, which the operating system 156 (as executed by the processor 12) may enable. Before continuing with the drawings, it should be noted that the operating system 156, in other embodiments, the operating system 156 may be any software or computer-readable instructions that may be executed by the processor 12 to manage and/or control wireless communication of the user equipment 10.

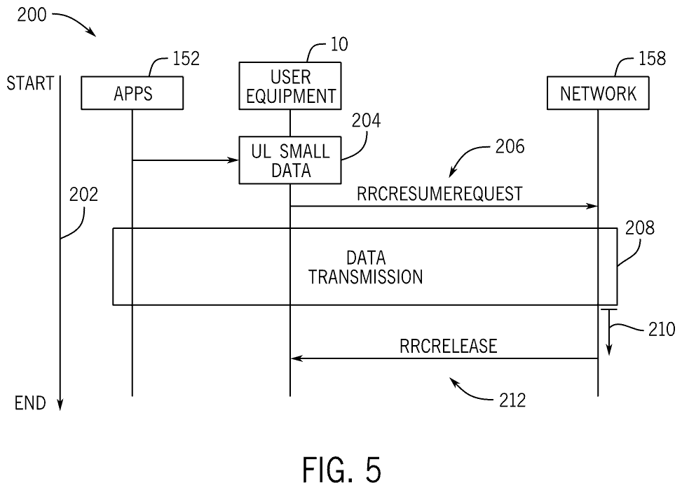

Bearing the discussion of FIG. 4 in mind, FIG. 5 is a timing diagram of a process 200 for communicating data between the user equipment 10 and the network 158 (which, as discussed above, may be or include the wireless communication network 102 or one or more of the base stations 104). Line 202 is indicative of time (with “start” referring to a starting time, and “end” referring to an ending time). Any suitable device (e.g., a controller) that may control components of the user equipment 10, the base station 104, and/or the network 102, such as the processor 12, may perform the process 200. In some embodiments, the process 200 may be implemented by executing instructions stored in a tangible, non-transitory, computer-readable medium, such as the memory 14 or storage 16, using the processor 12. For example, the process 200 may be performed at least in part by one or more software components, such as an operating system of the user equipment 10, the base station 104, and/or the network 102, one or more software applications of the user equipment 10, the base station 104, and/or the network 102, and the like. While the process 200 is described using steps in a specific sequence, it should be understood that the present disclosure contemplates that the described steps may be performed in different sequences than the sequence illustrated, and certain described steps may be skipped or not performed altogether. Moreover signals sent or received by the user equipment 10 or the base station 104 may be caused by the processor 12 of the user equipment 10 or the base station 104 causing the transmitter 52 of the user equipment 10 or the base station 104 to send the signals and the receiver 54 of the user equipment 10 or the base station 104 to receive the signals, respectively.

In process block 204, an application 152 (which may be an application of the one or more applications 152) may send a request to have data transmitted to the user equipment 10 (or, more specifically, the operating system 156 and/or processor 12 of the user equipment 10). For example, the request may be an uplink request for a small data transmission (SDT) session.

In process element 206, the operating system 156 and/or processor 12 of the user equipment 10 may send a request to enable a communication session to the network 158. For instance, the request may be an RRCResumeRequest, as used for SDT sessions. After the request is sent, a communication session (e.g., following SDT procedure) may occur between the user equipment 10 and the network 158.

In process block 208, data may be transmitted between the user equipment 10 and the network 158. More particularly, the data may be data that is associated with or generated for or by the application 152. As such, in process block 208, the application 152 may send and/or receive data from the network 158 via the user equipment 10 (e.g., via the transceiver 30 and/or processor 12 of the user equipment 10).

In process element 210, no data is transmitted between the user equipment 10 and the network 158 for a duration of time. The duration may be defined by the network 158 and may be any suitable amount of time. In other words, there is a period of time in which no data is conveyed (e.g., communicated, received, or transmitted) by the user equipment 10 or the network 158.

In process element 212, the network 158 may transmit a release message to the user equipment 10, thereby ending the wireless communication session between the user equipment 10 and the network 158. As illustrated, the release message may be an RRCRelease.

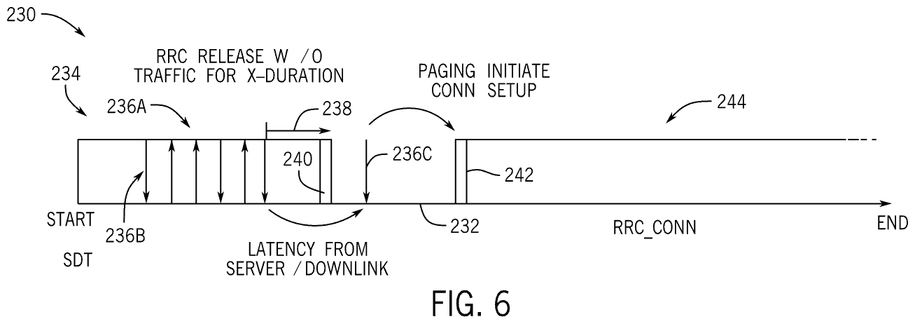

Keeping the discussion of FIG. 5 in mind, FIG. 6 is a timing diagram 230 illustrating wireless communication between the user equipment 10 and the network 158 in which “start” along line 232 refers to a starting time, and “end” along the line 232 refers to an ending time. The timing diagram 230 includes several portions that correspond to portions of the process 200 of FIG. 5. For example, the timing diagram 230 includes a SDT time period 234 during which data (e.g., as one or more wireless signals) is transmitted to (indicated by arrows 236A pointing away from the line 232) or received from (indicated by arrows 236B pointing towards the line 232) the network 158 (e.g., one of the base stations 104 of the wireless communication network 102). The SDT time period 234 corresponds to process block 208 of the process 200. The timing diagram 230 also includes a segment 238 during which no wireless signals are transmitted to the network 158 or received from the network 158 (e.g., during the SDT session). The segment 238 corresponds to the process element 210 of the process 200. Additionally, the timing diagram 230 includes a release 240 corresponding to process element 212 during which the wireless communication session between the user equipment 10 and the network 158 ends (e.g., due to the network 158 transmitting a release message.

As noted above, in some instances, there may be latency, and one or more wireless signals may not be received while a wireless communication session is active (e.g., during the SDT time period 234 or a time period running from when a wireless communication session begins to when the wireless communication session ends). For instance, a wireless signal (or data) represented by arrow 236C may be representative of a wireless signal transmitted by the network 158 that is not received by the user equipment 10 during the SDT time period 234, for example, due to latency of the network 158. In one embodiment, the wireless signal may be or include a push flag (e.g., a Transmission Control Protocol (TCP) PSH flag), which may be a control flag used to indicate that the receiving device should deliver the data to the receiving application as soon as possible, rather than buffering the data. For example, in the case of a TCP PSH flag, the PSH flag may instruct the user equipment 10 (or processor 12) to deliver the data immediately to the application 152 (or application layer) without waiting for more data to arrive.

At a time 242, the user equipment 10 (via the processor 12) may establish another wireless communication session 244 with the network 158, for example, by sending a request to establish the other wireless communication session 244 (which may be initiated by paging and connection setup procedures). The wireless communication session 244 may be non-SDT communication session (e.g., a wireless communication session other than an SDT wireless communication session), which may utilize more power (e.g., of the power source 29) than an SDT communication session would utilize. As discussed below, several techniques may be utilized to conserve power of the power source 29, for example, by extending a wireless communication session (e.g., an SDT communication session).

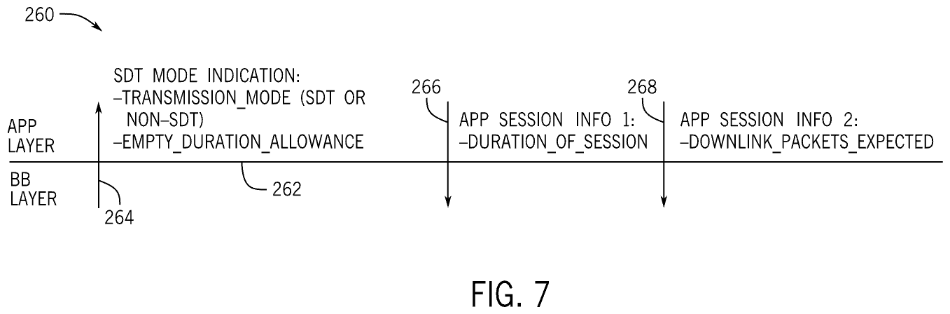

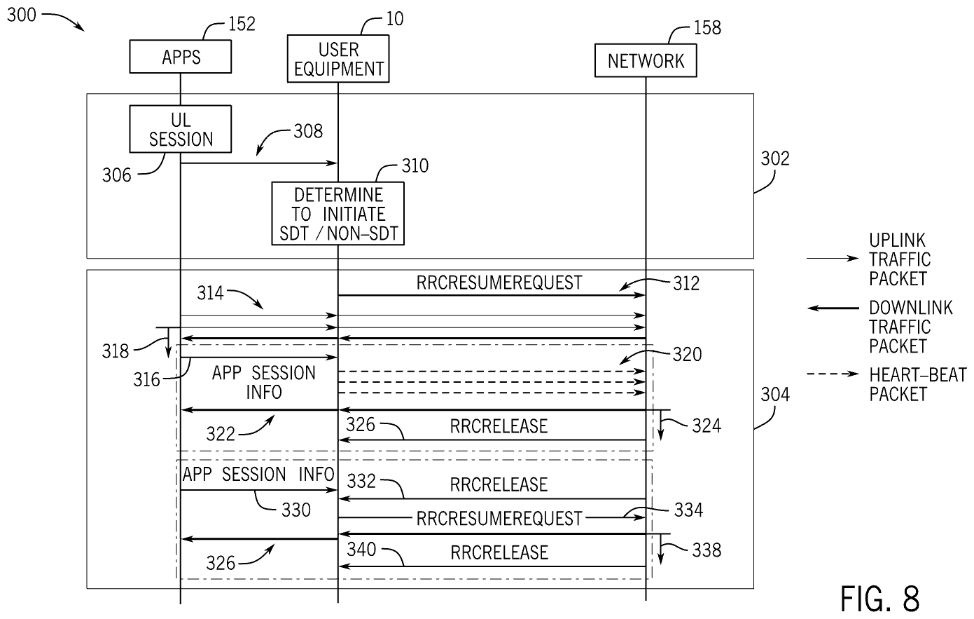

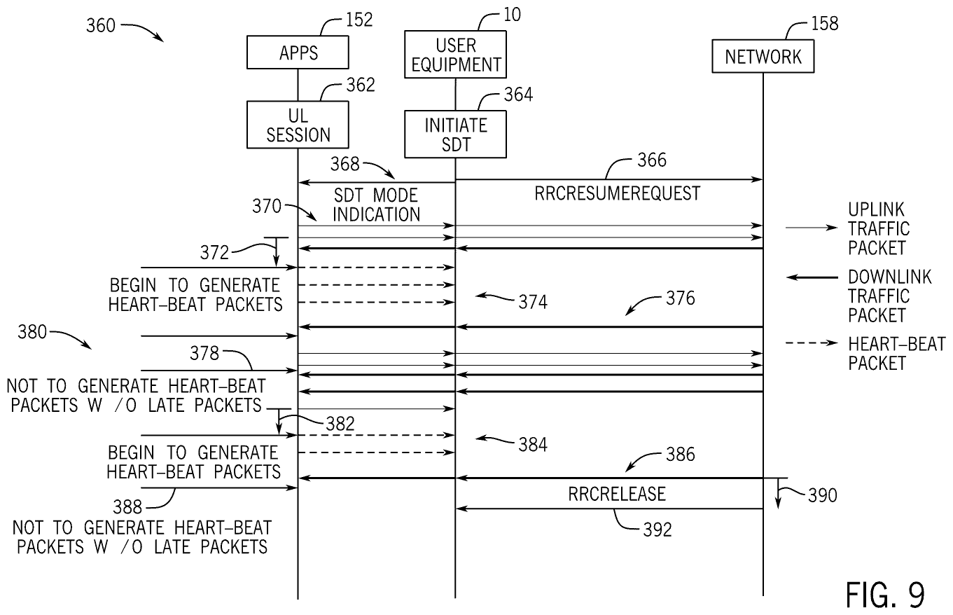

FIG. 7 is a diagram illustrative of a process 260 that may be performed by the user equipment 10 to share data between the application 152 and the processor 12 (or operating system 156 executed by the processor 12) that may be utilized as discussed below in more detail with respect to FIG. 8 and FIG. 9. FIG. 7 includes a line 262 utilized to indicate whether the application 152 performs or receives a result particular part of the process 260 as well as whether the processor 12 (e.g., via execution of the operation system 156 or other computer-readable instructions that can be used to control the transceiver 30) performs or receives a result of a particular portion of the process 260. Any suitable device (e.g., a controller) that may control components of the user equipment 10, the base station 104, and/or the network 102, such as the processor 12, may perform the process 260. In some embodiments, the process 260 may be implemented by executing instructions stored in a tangible, non-transitory, computer-readable medium, such as the memory 14 or storage 16, using the processor 12. For example, the process 260 may be performed at least in part by one or more software components, such as an operating system of the user equipment 10, the base station 104, and/or the network 102, one or more software applications of the user equipment 10, the base station 104, and/or the network 102, and the like. While the process 260 is described using steps in a specific sequence, it should be understood that the present disclosure contemplates that the described steps may be performed in different sequences than the sequence illustrated, and certain described steps may be skipped or not performed altogether. Moreover signals sent or received by the user equipment 10 or the base station 104 may be caused by the processor 12 of the user equipment 10 or the base station 104 causing the transmitter 52 of the user equipment 10 or the base station 104 to send the signals and the receiver 54 of the user equipment 10 or the base station 104 to receive the signals, respectively.

In process element 264, the processor 12 may send (via the API 154) an indication to the application 152. The indication may be indicative of a transmission mode between the user equipment 10 and the network. In other words, the indication may be indicative of a type of wireless communication session, such as whether the wireless communication session is an SDT or non-SDT communication session. Additionally (or alternatively), the indication may be indicative of an empty duration allowance, which is a duration of time the network 158 may wait before transmitting a release message (e.g., RRCRelease). As discussed in more detail below (with respect to FIG. 8 and FIG. 9), SDT communication sessions may be extended (or initiated) based on the empty duration allowance.

Continuing with the discussion of the process 260, in process element 266, the application 152 may send (via the API 154) to the processor 12 an indication of a duration of session. The duration of session may be an estimated duration of a wireless communication session between the user equipment 10 and the network 158. For example, the estimated duration may be the amount of time that the application 152 has determined may be utilized to transmit data to the network 158, receive data from the network 158, or transmit and receive data from the network 158. As discussed below with respect to FIG. 8, the processor 12 may utilize the indication to determine which type of wireless communication session (e.g., SDT or non-SDT) for which to send a request to the network 158.

In process element 268, the application 152 may send (via the API 154) to the processor 12 a second indication of data packets expected to be received (from the network 158). In other words, the application 152 may indicate that there is more data that the application 152 has determined be expected to be received (e.g., by the transceiver 30) from the network 158. The second indication may be indicative of particular types of data packets, such as, but not limited to push flags (e.g., TCP PSH flags) or notification packets. As discussed below, the user equipment 10 may extend a wireless communication session (e.g., an SDT communication session) based at least in part on the second indication. Before proceeding to discuss FIG. 8, it should be noted that in some embodiments, the process 260 may omit process element 266 or process element 268. Additionally, in other embodiments, the indications discussed above with respect to process element 266 and process element 268 may be provided in one indication or at the same time.

FIG. 8 is a flow diagram of a process 300 for wireless communication between the user equipment 10 and the network 158. As discussed below, the process 300 may include either or both of two techniques that may utilize one or more SDT communication sessions. Any suitable device (e.g., a controller) that may control components of the user equipment 10, the base station 104, and/or the network 102, such as the processor 12, may perform the process 300. In some embodiments, the process 300 may be implemented by executing instructions stored in a tangible, non-transitory, computer-readable medium, such as the memory 14 or storage 16, using the processor 12. For example, the process 300 may be performed at least in part by one or more software components, such as an operating system of the user equipment 10, the base station 104, and/or the network 102, one or more software applications of the user equipment 10, the base station 104, and/or the network 102, and the like. While the process 300 is described using steps in a specific sequence, it should be understood that the present disclosure contemplates that the described steps may be performed in different sequences than the sequence illustrated, and certain described steps may be skipped or not performed altogether. Moreover signals sent or received by the user equipment 10 or the base station 104 may be caused by the processor 12 of the user equipment 10 or the base station 104 causing the transmitter 52 of the user equipment 10 or the base station 104 to send the signals and the receiver 54 of the user equipment 10 or the base station 104 to receive the signals, respectively.

The process 300 generally includes two portions: a first portion 302 and a second portion 304 The first portion 302 generally relates to determining a type of wireless communication session (to request by the user equipment 10), while the second portion 304 generally relates to extending the wireless communication session (e.g., an SDT communication session), preventing the network 158 from ending the wireless communication session, and/or establishing another wireless communication session (e.g., a second SDT communication session). Bearing this in mind, in process block 306, the application 152 may send a request to the processor 12 to transmit data. For example, the application 152 may request access to the transceiver 30 of the user equipment 10 to transmit data to the network 158. In other embodiments, the application 152 may initiate an uplink session in which data is to be transmitted to the network 158 (by the user equipment 10).

At process element 308, the application 152 may send application session information to the processor 12. The application session information may be, include, or indicate the duration of session (e.g., as discussed above with respect to process element 266 of the process 260). In process element 310, the processor 12 may determine a type of wireless communication session based on the duration of session (as indicated by the application session information included at process element 308). For example, the processor 12 may determine whether to request an SDT communication session with the network 158 based on the duration of session being less than a threshold amount of time. In such a case, when the duration of session is less than the threshold amount of time, the processor 12 may determine to request an SDT communication session with the network 158. If the duration of session is equal to or greater than the threshold amount of time, the processor 12 may determine to request a non-SDT communication session with the network 158.

Continuing to the second portion 304 of the process 300 (e.g., in a case in which the processor 12 determines to request an SDT communication session with the network 158), at process element 312, the processor 12 of the user equipment 10 may transmit a request to enable a communication session to the network 158. For instance, the request may be an RRCResumeRequest, as used for SDT communication sessions. After the request is sent, a communication session (e.g., following SDT procedure) may occur between the user equipment 10 and the network 158.

In process element 314, data may be transmitted between the user equipment 10 and the network 158. More particularly, the data may be data that is associated with or generated for or by the application 152. As such, in process block 208, the application 152 may send and/or receive data from the network 158 via the user equipment 10 (e.g., via the transceiver 30 and/or processor 12 of the user equipment 10).

In process element 316, the application may send additional application session information to the processor 12. More specifically, the application 152 may send (via the API 154) to the processor 12 a second indication of data packets expected to be received (from the network 158). In other words, the application 152 may indicate that there is more data that the application 152 has determined be expected to be received (e.g., by the transceiver 30) from the network 158. The second indication may be indicative of particular types of data packets, such as, but not limited to push flags (e.g., TCP PSH flags). In some embodiments, the application 152 may first determine whether there is additional data to be received (e.g., during time 318 during which no data is transmitted between the user equipment 10 and the network 158) and send the additional application session information based on determining there is data expected to be received that has not been received.

Based on receiving the additional application session information that is indicative of there being data expected to be received, in process element 320, the processor 12 may generate one or more data packets and transmit (via the transceiver) the one or more data packets to the network 158, for example, to extend the SDT communication session and/or to prevent the network 158 from transmitting a release message to end the SDT communication session. These data packets may be referred to as “heartbeat packets” and may be relatively small in terms of amount of data (e.g., fewer than ten kilobytes, fewer than five kilobytes, or any other suitable amount of data). However, because the network 158 continues to receive data (e.g., one or more heartbeat packets), the SDT communication session may continue. Because the SDT communication session is prolonged, the data expected to be received may subsequently be received (as indicated by process element 322). In some embodiments, in process block 320, the processor 12 may cause the heartbeat packets to be sent at a regular interval, such as a period of time that is less than the empty duration allowance, until the data expected to be received is received. Accordingly, the user equipment 10 may transmit data packets to prolong an SDT communication session and/or prevent the network 158 from ending the SDT communication session.

In some embodiments, the one or more data packets communicated in process element 320 may include one or more scheduling request (SR) messages, one or more buffer status report (BSR) messages, or both one or more SR messages and one or more BSR messages. SR messages may be used for requesting uplink scheduling (UL-SCH) resources for new transmission (to the network 158). BSR messages may be utilized to indicate data available in a data buffer of the user equipment 10 (e.g., ready for transmission).

After the data expected to be received is received, the processor 12 may stop causing the heartbeat packets to be transmitted and, as indicated by arrow 324, a period of time in which no data is transmitted between the user equipment 10 and the network 158 may occur. In other words, the processor 12 may end the communication of data packets discussed above with respect to process element 320 based on data expected to be received being received. Additionally, after the communication of the data packets has ended, the period of time indicated by arrow 324 during which there is no communication between the user equipment 10 and the network 158 may occur. As noted above, this period of time may be defined by the network 158 and may be any suitable amount of time. In process element 326, the network 158 may transmit a release message to the user equipment 10, thereby ending the wireless communication session between the user equipment 10 and the network 158. As illustrated, the release message may be an RRCRelease.

Another technique (which may be used in addition to or as an alternative to utilizing heartbeat packets) to ensuring that the data expected to be received is received (e.g., without utilizing a non-SDT communication session) after an SDT communication session has been initialized may also be used. In this technique, in process element 330, the additional application session information is received. In process element 332, the network 158 transmits a release message (e.g., RRCRelease). Based on receiving the release message and there being data expected to be received (e.g., as indicated by the additional application session information), in process element 334, the processor 12 may send a second another request for a communication session (e.g., a RRCResumeRequest to establish a second SDT communication session), for example, to enable the user equipment 10 to receive data transmitted by the network 158 during an initial SDT communication session or after the initial SDT communication session ends (but before the user equipment 10 receives the 10).

During the second SDT communication session, in process element 336, the user equipment 10 may receive the data that was expected to be received (as indicated by the additional application session information). After a duration of time has elapsed during which no data is transmitted or received (as indicated by arrow 338), in process element 340, the network 158 may transmit a release message to the user equipment 10, thereby ending the second SDT communication session between the user equipment 10 and the network 158. As illustrated, the release message may be an RRCRelease. Accordingly, the process 300 (or portions or elements thereof) may be performed to extend the SDT communication session, prevent the network 158 from transmitting a release message to end the SDT communication session, and/or, based on receiving a release message, establish a second communication session (e.g., an SDT communication session). By utilizing one or more of these techniques, the user equipment 10 may consume less power (e.g., of the power source 29), for example, relative to utilizing non-SDT communication techniques.

Continuing with the drawings, FIG. 9 is a flow diagram of another process 360 for wireless communication between the user equipment 10 and the network 158. Similar to the process 300, the process 360 may be performed to extend a wireless communication session (e.g., SDT communication session) between the user equipment 10 and the network 158 and/or to prevent the network 158 from ending the wireless communication session. With this in mind, any suitable device (e.g., a controller) that may control components of the user equipment 10, the base station 104, and/or the network 102, such as the processor 12, may perform the process 360. In some embodiments, the process 360 may be implemented by executing instructions stored in a tangible, non-transitory, computer-readable medium, such as the memory 14 or storage 16, using the processor 12. For example, the process 360 may be performed at least in part by one or more software components, such as an operating system of the user equipment 10, the base station 104, and/or the network 102, one or more software applications of the user equipment 10, the base station 104, and/or the network 102, and the like. While the process 360 is described using steps in a specific sequence, it should be understood that the present disclosure contemplates that the described steps may be performed in different sequences than the sequence illustrated, and certain described steps may be skipped or not performed altogether. Moreover signals sent or received by the user equipment 10 or the base station 104 may be caused by the processor 12 of the user equipment 10 or the base station 104 causing the transmitter 52 of the user equipment 10 or the base station 104 to send the signals and the receiver 54 of the user equipment 10 or the base station 104 to receive the signals, respectively.

In process block 362, the application 152 may send a request to the processor 12 to transmit data. For example, the application 152 may request access to the transceiver 30 of the user equipment 10 to transmit data to the network 158. In other embodiments, the application 152 may initiate an uplink session in which data is to be transmitted to the network 158 (by the user equipment 10).

In process block 364, the processor 12 of the user equipment 10 may determine to initiate a wireless communication session (e.g., SDT communication session), and, in process element 366, the processor 12 may transmit a request to enable a communication session to the network 158. For instance, the request may be an RRCResumeRequest, as used for SDT communication sessions. After the request is sent, a communication session (e.g., following SDT procedure) may occur between the user equipment 10 and the network 158.

In process element 368, the processor 12 may send a mode indication to the application 152. The mode indication may be indicative of the type of wireless communication session (e.g., SDT or non-SDT) and (for SDT communication sessions), the empty duration allowance. As discussed above, the empty duration allowance may be an amount of time after which no data has been transmitted or received by the user equipment 10 or the network 158, the network may end the wireless communication session.

In process element 370, data may be transmitted between the user equipment 10 and the network 158. More particularly, the data may be data that is associated with or generated for or by the application 152. As such, in process block 208, the application 152 may send and/or receive data from the network 158 via the user equipment 10 (e.g., via the transceiver 30 and/or processor 12 of the user equipment 10).

After no data has been transmitted or received for a duration of time (indicated by arrow 372), which may be less than the empty duration allowance, in process element 374 the application 152 send to the processor 12 heartbeat packets or an indication to transmit heartbeat packets. For example, based on determining that there is data expected to be received from the network 158 and/or the empty duration allowance, the application 152 may determine that the wireless communication session should be extended and thereby send heartbeat packets (or an indication to transmit heartbeat packets) to the processor 12. In some embodiments, the application 152 may determine an interval at which to send the heartbeat packets and indicate such an interval to the processor 12.

Data packets (e.g., heartbeat packets) may continue to be transmitted, for example, until the data expected to be received is received (as indicated by process element 376). In process element 378, the application 152 may stop the transmission of heartbeat packets based on the expected data being received.

In process element 380, additional data may be transmitted between the user equipment 10 and the network 158. Similar to above, after no data has been transmitted or received for a duration of time (indicated by arrow 382), which may be less than the empty duration allowance, in process element 384 the application 152 send to the processor 12 heartbeat packets or an indication to transmit heartbeat packets. Data packets (e.g., heartbeat packets) may continue to be transmitted, for example, until the data expected to be received is received (as indicated by process element 386). In process element 388, the application 152 may stop the transmission of heartbeat packets based on the expected data being received. Furthermore, after no data has been transmitted or received for a duration of time (indicated by arrow 390), which may be equal to or greater than the empty duration allowance, in process element 392, the network 158 may transmit a release message (e.g., RRCRelease) to end the wireless communication session. In this manner, the process 360 enables the user equipment 10 (via the application 152) to extend an SDT communication, which may reduce power consumption of the user equipment 10 (e.g., compared to utilizing non-SDT communication sessions).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
a transceiver; and
processing circuitry operatively coupled to the transceiver, wherein the processing circuitry is configured to
transmit, via the transceiver and to a second electronic device, a request for a wireless communication session with the second electronic device,
communicate, via the transceiver, one or more first wireless signals during the wireless communication session with the second electronic device, and
after communicating the one or more first wireless signals, extend the wireless communication session by transmitting, via the transceiver and to the second electronic device, one or more second wireless signals based on no wireless signals being communicated via the wireless communication session for a duration of time.

2. The electronic device of claim 1, wherein the wireless communication session comprises a small data transfer (SDT) in accordance with Third Generation Partnership Project (3GPP) Release 17.

3. The electronic device of claim 1, wherein the processing circuitry is configured to receive, from an application executed by the processing circuitry, an indication indicative of an expected duration of the wireless communication session.

4. The electronic device of claim 3, wherein the processing circuitry is configured to
transmit, via the transceiver, the request for the wireless communication session as a request for a small data transfer (SDT) based on the expected duration of the wireless communication session being less than a threshold amount of time, and
transmit, via the transceiver, the request for the wireless communication session as a request for a non-SDT communication session based on the expected duration of the wireless communication session being equal to or greater than the threshold amount of time.

5. The electronic device of claim 1, wherein the processing circuitry is configured to
receive from an application executed by the processing circuitry, an indication of data packets expected to be received from the second electronic device, and
transmit, via the transceiver, the one or more second wireless signals based on one or more data packets of the data packets expected to be received having not been received.

6. The electronic device of claim 1, wherein the processing circuitry is configured to
receive, from an application executed by the processing circuitry, an indication of data packets expected to be received from the second electronic device,
receive, via the transceiver and from the second electronic device, a release message to end the wireless communication session.

7. The electronic device of claim 6, wherein the processing circuitry is configured to, based on receiving the release message and one or more data packets of the data packets expected to be received having not been received:
transmit, via the transceiver, a RRCResumeRequest to establish a small data transfer (SDT) wireless communication session with the second electronic device; and
receive, during the wireless communication session and the SDT wireless communication session, a third wireless signal transmitted by the second electronic device.

8. The electronic device of claim 1, wherein the second electronic device comprises or is included in a base station of a cellular network.

9. The electronic device of claim 1, wherein the request for the wireless communication session comprises a RRCResumeRequest.

10. A non-transitory computer-readable medium comprising instructions that, when executed by processing circuitry of an electronic device, cause the processing circuitry to:
transmit, via a transceiver of the electronic device and to a base station of a wireless communication network, a request for a wireless communication session with the base station over the wireless communication network;
communicate, via the transceiver, one or more first wireless signals during the wireless communication session with the base station;
after communicating the one or more first wireless signals, prevent the base station from ending the wireless communication session by transmitting, via the transceiver and to the base station, one or more second wireless signals based on no wireless signals being communicated via the wireless communication session for a duration of time.

11. The non-transitory computer-readable medium of claim 10, wherein the instructions, when executed, cause the processing circuitry to
receive from an application executed by the processing circuitry, an indication of data packets expected to be received from the base station, and
transmit, via the transceiver, the one or more second wireless signals in response to one or more data packets of the data packets expected to be received having not been received.

12. The non-transitory computer-readable medium of claim 11, wherein the instructions, when executed, cause the processing circuitry to transmit, via the transceiver, each of the one or more second wireless signals at a time interval until the data packets expected to be received have been received.

13. The non-transitory computer-readable medium of claim 11, wherein the data packets expected to be received comprise one or more push flags.

14. The non-transitory computer-readable medium of claim 10, wherein the instructions, when executed, cause the processing circuitry to
receive one or more data packets generated by an application executed by the processing circuitry,
generate the one or more second wireless signals based on receiving the one or more data packets.

15. The non-transitory computer-readable medium of claim 14, wherein the one or more second wireless signals comprise the one or more data packets.

16. The non-transitory computer-readable medium of claim 14, wherein the instructions, when executed, cause the processing circuitry to receive, via the transceiver and from the base station, an indication of the duration of time.

17. The non-transitory computer-readable medium of claim 14, wherein the instructions, when executed, cause the processing circuitry to receive, from the application, an indication of the duration of time.

18. A computer-implemented method comprising:
receiving, via a transceiver, a request for a small data transmit (SDT) wireless communication session;
communicating, via the transceiver, one or more first wireless signals during the SDT wireless communication session, and
receiving, via the transceiver, one or more second wireless signals that extend the SDT wireless communication session based on no wireless signals being communicated via the SDT wireless communication session for a duration of time.

19. The computer-implemented method of claim 18, comprising sending, via the transceiver, a second indication of the duration of time.

20. The computer-implemented method of claim 18, wherein the transceiver is of a base station of a 3rd generation (3G) cellular network, a 4th generation (4G) cellular network, a 5th generation (5G) cellular network, or a 6th generation (6G) cellular network.
